(19) United States
(12) Patent Application Publication
(10) Pub. No.: US 2016/0270443 A1
(43) Pub. Date: Sep. 22, 2016

(54) ELECTRONIC CIGARETTE

(71) Applicant: KIMREEHI-TECH INC., Road Town, Tortola (VG)

(72) Inventor: Qiuming LIU, Huizhou, Guangdong (CN)

(21) Appl. No.: 14/407,602

(22) PCT Filed: Dec. 20, 2013
(86) PCT No.: PCT/CN2013/090070

§ 371 Date: Dec. 12, 2014

(30) Foreign Application Priority Data
Nov. 25, 2013 (CN) 201320752209.4

(51) Int. Cl. A24F 47/00; H05B 3/00; G05B 15/02

(52) U.S. Cl. CPC A24F 47/008; G05B 15/02; H05B 3/0014

(57) ABSTRACT

An electronic cigarette is provided, which includes: a setting assembly for setting time and the number of times of suction; a main controller, which is connected to the setting assembly and is for controlling the number of times of generation of a switch instruction within a preset time to be not bigger than a preset number of times of suction; and a switching assembly, which is connected to the main controller and an atomizer and is for controlling, based on the switch instruction generated by the main controller, turning on or turning off of the atomizer. With the electronic cigarette, the number of times of suction of a smoker within the preset time is controlled to be not bigger than the preset number of times of suction, thereby controlling the smoking quantity of the smoker within the preset time.

This application claims the benefit of priority to Chinese patent application No. 201320752209.4, titled “ELECTRONIC CIGARETTE” and filed with the State Intellectual Property Office of the People's Republic of China on Nov. 25, 2013, the entire disclosure of which is incorporated herein by reference.

### FIELD

The present application relates to the technical field of electronic cigarette, and in particular, to an electronic cigarette.

### BACKGROUND

The electronic cigarette is an electronic product simulating the cigarette. Cigarette liquid is evaporated into steam by an atomizer and a smoker inhales the steam directly. It seems like smoking at a cursory glance; actually, no smoke is generated during the process.

The electronic cigarette includes a battery rod and an atomizer. The output quantity of the steam and the working state are controlled by a control circuit and an airflow sensor which are provided in the battery rod. When the smoker breathes in, a high speed airflow may be caused; the airflow sensor generates a smoking signal after the airflow is sensed by the airflow sensor; a controller generates a switch instruction based on a detected smoking signal and sends the switch instruction to a switch assembly, to turn on the atomizer through the switch assembly. A heating wire is heated after the atomizer is turned on, and thus the cigarette liquid is evaporated and atomized, to form the steam simulating the smoke. Accordingly, the atomizer is turned on once each time the smoker performs a suction, that is, the number of times of suction performed by the smoker is equal to the number of times of turning on of the atomizer.

Although the electronic cigarette may reduce the harm of the cigarette to the smoker to some extent, it is required to control the smoking quantity of the smoker to further reduce the harm of smoking to the health of the smoker. However, conventional electronic cigarettes may not control the smoking quantity of the smoker within a certain time.

### SUMMARY

In view of this, an electronic cigarette is provided in the application, to solve the problem that the conventional electronic cigarettes may not control the smoking quantity of the smoker within a certain time.

To achieve the above objective, a technical solution provided in the present application is described as follows.

An electronic cigarette includes:
a setting assembly, which is for setting time and setting the number of times of suction;
a main controller, which is connected to the setting assembly, and controls the number of times of generation of a switch instruction within a preset time to be not bigger than a preset number of times of suction; and
a switch assembly, which is connected to the main controller and an atomizer, and controls, based on the switch instruction generated by the main controller, turning on or turning off of the atomizer.

Preferably, the electronic cigarette further includes:
a storage, which is for storing the set number of times of suction and the set time.

Preferably, the electronic cigarette further includes:
a counter-and-timer, which is for recording time at which the atomizer is turned on within the preset time and the number of times of turning on of the atomizer within the preset time.

Preferably, the main controller is an MSP430F5529 microprocessor.

Preferably, the switch assembly is a metal oxide semiconductor field effect transistor.

Preferably, the setting assembly is a button or a hand wheel.

Preferably, if the setting assembly is a button, the electronic cigarette includes:
a first button, which is for setting the number of times of suction; and
a second button, which is for setting time.

Preferably, the time or the number of times of suction may be set by pressing the buttons to select different gears or to increase or decrease a certain number.

Preferably, if the setting assembly is a hand wheel, the electronic cigarette includes:
a first hand wheel, which is for setting the number of times of suction; and
a second wheel, which is for setting time.

Preferably, the time or the number of times of suction may be set by rotating the hand wheels to select different gears or to increase or decrease a certain number.

Compared with conventional technologies, the technical solution provided in the application has the following advantages.

In the electronic cigarette provided in the application, the time and the number of times of suction are set by the setting assembly; the number of times of generation of the switch instruction within the preset time is controlled, by the main controller, to be not bigger than the preset number of times of suction; and turning on or turning off of the atomizer is controlled, by the switch assembly connected to the main controller, based on the switch instruction. It may be seen that, with the electronic cigarette provided in the application, the number of times of generation of the switch instruction within the preset time may be controlled by the main controller, to control the number of times of turning on of the atomizer within the preset time; hence, the number of times of suction of a smoker within the preset time is controlled to be not bigger than the preset number of times of suction, thereby controlling the smoking quantity of the smoker within the preset time and solving the problem that the conventional electronic cigarettes may not control the smoking quantity of the smoker within a certain time.

### BRIEF DESCRIPTION OF THE DRAWINGS

For more clearly illustrating a technical solution according to embodiments of the present application or conventional technologies, drawings to be used in descriptions of the embodiments or the conventional technologies are briefly introduced hereinafter. Apparently, the drawings are merely used to illustrate some embodiments of the present application, and those of ordinary skill in the art may achieve other drawings based on these drawings without any creative efforts.

FIG. 1 is a schematic structure diagram of an electronic cigarette according to an embodiment of the application.

### DETAILED DESCRIPTION OF THE EMBODIMENTS

As described in the background, although the cigarette liquid of the electronic cigarette does not contain tar or other harmful ingredients, which may reduce the harm of the cigarette to the health of a smoker or a non-smoker to some extent, it is required to control the smoking quantity of the smoker to further reduce the harm of smoking to the health of the smoker; while, the conventional electronic cigarettes may not control the smoking quantity of the smoker within a certain time.

This is because a conventional electronic cigarette only may control turning on or turning off of the atomizer through the switch assembly and may not control the number of times of turning on of the atomizer within a certain time, that is, the number of times of suction of the smoker within the certain time may not be controlled. Hence, the conventional electronic cigarettes may not control the smoking quantity of the smoker within a certain time.

In view of this, an electronic cigarette is provided in the application to solve the above problem in conventional technologies. The electronic cigarette includes:
a setting assembly, which is for setting time and the number of times of suction;
a main controller, which is connected to the setting assembly and controls the number of times of generation of a switch instruction within a preset time to be not bigger than a preset number of times of suction; and
a switch assembly, which is connected to the main controller and an atomizer and controls, based on the switch instruction generated by the main controller, turning on or turning off of the atomizer.

In the electronic cigarette provided in the application, the time and the number of times of suction are set by the setting assembly; the number of times of generation of the switch instruction within the preset time is controlled, by the main controller, to be not bigger than the preset number of times of suction; and turning on or turning off of the atomizer is controlled, by the switch assembly connected to the main controller, based on the switch instruction. It may be seen that, with the electronic cigarette provided in the application, the number of times of generation of the switch instruction within the preset time may be controlled by the main controller, to control the number of times of turning on of the atomizer within the preset time; hence, the number of times of suction of a smoker within the preset time is controlled to be not bigger than the preset number of times of suction, thereby controlling the smoking quantity of the smoker within the preset time and solving the problem that the conventional electronic cigarettes may not control the smoking quantity of the smoker within a certain time.

What described above is the core mind of the present application. To make the above objective, features and advantages of the present application clearer and better understood, embodiments of the present application are detailed hereinafter in conjunction with drawings.

In the following description, numerous specific details are set forth to fully understand the present application. The present application may also be implemented in other ways different from those described herein. Similar extension may be made by those skilled in the art without departing from the mind of the application. Hence, the present application is not limited to the following disclosed embodiments.

Secondly, the present application is described in detail in conjunction with schematic diagram, and in detailing the embodiments of the present application, a sectional view illustrating a device structure may be partially enlarged in a non-determined scale. The schematic diagram is only exemplary and should not limit the scope of protection of the application. In addition, a three-dimensional space size of length, width and depth should be taken into consideration in actual manufacturing.

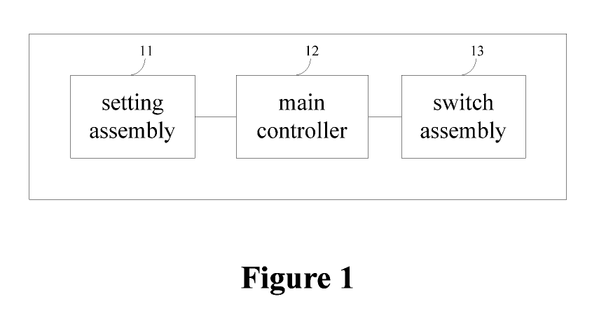

An electronic cigarette is provided according to an embodiment of the application. FIG. 1 is a schematic structure diagram of the electronic cigarette. The electronic cigarette includes a setting assembly 11, a main controller 12, and a switch assembly 13.

The setting assembly 11 is for setting time and the number of times of suction; the main controller 12 is connected to the setting assembly 11 and is for controlling the number of times of generation of a switch instruction within a preset time to be not bigger than a preset number of times of suction; and the switch assembly 13 is connected to the main controller and an atomizer, and is for controlling, based on the switch instruction generated by the main controller, turning on or turning off of the atomizer.

The electronic cigarette further includes a counter-and-timer and a storage. The counter-and-timer is for recording time at which the atomizer is turned on within the preset time and the number of times of turning on of the atomizer within the preset time. The storage is for storing the set number of times of suction and the set time.

In the embodiment, the main controller is a microprocessor, and the switch assembly may be a Metal oxide semiconductor field effect transistor (MOS transistor). Preferably, the main controller is an MSP430F5529 microprocessor, the switch assembly is a 3400 MOS transistor, and the setting assembly is a button or a hand wheel.

According to an embodiment, if the setting assembly is a button, the electronic cigarette includes a first button and a second button which are set on an external housing of the electronic cigarette. The first button is for setting the number of times of suction, and the second button is for setting the time. That is, the time or the number of times of suction may be set through pressing the buttons to select different gears or to increase or decrease a certain number.

Of course according to other embodiments, a hand wheel may be applied instead of the button to set the time and the number of times of suction. According to other embodiments, if the setting assembly is a hand wheel, the electronic cigarette includes a first hand wheel and a second hand wheel which are set on the external housing of the electronic cigarette. The first hand wheel is for setting the number of times of suction, and the second hand wheel is for setting the time. That is, the time or the number of times of suction may be set through rotating the hand wheels to select different gears or to increase or decrease a certain number.

Before using the electronic cigarette, the number of times of suction is set through pressing the first button or through rotating the first hand wheel to select different gears or to increase or decrease a certain number; and the time is set through pressing the second button or through rotating the second hand wheel to select different gears or to increase or decrease a certain number. After the time and the number of times of suction are preset, the main controller 12 controls, based on the preset time and the preset number of times of suction, the number of times of generation of the switch instruction within the preset time to be not bigger than the preset number of times of suction, thereby controlling the number of times of turning on of the atomizer to be not bigger than the preset number of times of suction, where the atomizer is turned on by the switch assembly 13.

When the smoker uses the electronic cigarette, an airflow sensor generates a smoking signal after an airflow is sensed by the airflow sensor. After the smoking signal is detected by the main controller 12, the main controller 12 generates the switch instruction based on the smoking signal, and controls, through the switch instruction, the switch assembly 13 to switch on to turn on the atomizer; a heating wire in the atomizer is heated and the cigarette liquid is atomized into steam. In a case that the number of times of turning on of the atomizer within the preset time, which is recorded by the counter-and-timer in the electronic cigarette, is equal to the preset number of times of suction, the main controller 12 may not further generate the switch instruction within the preset time. Hence, before the preset time terminates, the atomizer may not be turned on when the smoker uses the electronic cigarette, and accordingly, the number of times of suction of the smoker within the preset time is controlled to be not bigger than the preset number of times of suction, thereby controlling the smoking quantity of the smoker within the preset time. The preset time and the preset number of times of suction may be set based on specific condition of the smoker.

In the electronic cigarette provided in the application, the time and the number of times of suction are set by the setting assembly; the number of times of generation of the switch instruction within the preset time is controlled, by the main controller, to be not bigger than the preset number of times of suction; and turning on or turning off of the atomizer is controlled, by the switch assembly connected to the main controller, based on the switch instruction. It may be seen that, with the electronic cigarette provided in the application, the number of times of generation of the switch instruction within the preset time may be controlled by the main controller, to control the number of times of turning on of the atomizer within the preset time; hence, the number of times of suction of a smoker within the preset time is controlled to be not bigger than the preset number of times of suction, thereby controlling the smoking quantity of the smoker within the preset time and solving the problem that the conventional electronic cigarettes may not control the smoking quantity of the smoker within a certain time.

The embodiments of the present application are described in a progressive manner, and every embodiment focuses on illustrating differences from other embodiments. Same or similar parts between the embodiments may be referred to each other. With the foregoing description of the embodiments disclosed, those skilled in the art may implement or use the present application. Various modifications to these embodiments may be apparent to those skilled in the art, and the general principle defined herein may be implemented by other embodiments without departing from the spirit or the scope of the present application. Therefore, the present application may not be limited to the embodiments disclosed herein, but should conform to a broadest scope consistent with the principle and novel features disclosed herein.

1. An electronic cigarette, comprising:
a setting assembly, configured to set time and the number of times of suction;
a main controller, which is connected to the setting assembly and controls the number of times of generation of a switch instruction within a preset time to be not bigger than a preset number of times of suction; and
a switch assembly, which is connected to the main controller and an atomizer and controls, based on the switch instruction generated by the main controller, turning on or turning off of the atomizer.

2. The electronic cigarette according to claim 1, further comprising:
a storage configured to store the set number of times of suction and the set time.

3. The electronic cigarette according to claim 2, further comprising:
a counter-and-timer, configured to record time at which the atomizer is turned on within the preset time and the number of times of turning on of the atomizer within the preset time.

4. The electronic cigarette according to claim 3, wherein the main controller is an MSP430F5529 microprocessor.

5. The electronic cigarette according to claim 4, wherein the switch assembly is a metal oxide semiconductor field effect transistor.

6. The electronic cigarette according to claim 5, wherein the setting assembly is a button or a hand wheel.

7. The electronic cigarette according to claim 6, wherein if the setting assembly is a button, the electronic cigarette comprises:
a first button, configured to set the number of times of suction; and
a second button, configured to set the time.

8. The electronic cigarette according to claim 7, wherein the time or the number of times of suction is set by pressing the buttons to select different gears or to increase or decrease a certain number.

9. The electronic cigarette according to claim 6, wherein if the setting assembly is a hand wheel, the electronic cigarette comprises:
a first hand wheel, configured to set the number of times of suction; and
a second wheel, configured to set the time.

10. The electronic cigarette according to claim 9, wherein the time or the number of times of suction is set by rotating the hand wheels to select different gears or to increase or decrease a certain number.
